(19) United States
(12) Patent Application Publication
(10) Pub. No.: US 2002/0194026 A1
(43) Pub. Date: Dec. 19, 2002

(54) System and method for managing data and documents

(76) Inventors: Jeffrey Lawrence Klein, Decatur, GA (US); Andrew Timothy Hopper, Tucker, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/172,274

(22) Filed: Jun. 13, 2002

Related U.S. Application Data
(60) Provisional application No. 60/297,939, filed on Jun. 13, 2001.

(51) Int. Cl. G06F 17/60

(52) U.S. Cl. 705/2

(57) ABSTRACT

A data management system accepts input documents having a variety of formats from multiple sources. Typically one or more formats are associated with a source. A document reader parses an input documents using a set of rules. The rules are tailored to the source that provided the document. The rules use format and context to extract data. The data extracted from the input document is stored in a document database and indexed. Typically, demographic data and clinical data are extracted from the input document and the demographic data is used to index the document.

### RELATED APPLICATION

This U.S. patent application claims priority to U.S. Provisional Patent Application Serial No. 60/297,939 entitled “Data Management System and Method” filed Jun. 13, 2001 which is incorporated herein by reference.

### TECHNICAL FIELD

The present invention is directed in general to extracting and storing data, and in particular to receiving documents from different sources and extracting data from the documents so that the data can be easily searched and retrieved.

### BACKGROUND

Despite advances in technology, medical practices have been slow to adopt electronic medical databases and electronic medical records (“EMR”) systems, in part, because the available systems require that a physician modify the physician's current mode of practice. Many physicians and caregivers dictate visit notes after examining a patient. However, many of the current systems do not accept dictated visit notes as input. Instead the systems require that the caregiver enter visit notes using a particular input format. In particular, some systems require that the caregiver navigate a series of menus to enter the information that the caregiver would typically dictate. Because these systems require that the caregiver use a particular input format that is incompatible with the caregiver's current mode of practice, these systems have not been readily accepted. Thus, there is a need for an EMR system that accepts dictated input and that does not require a caregiver to modify the caregiver's current mode of practice.

If several caregivers are treating a patient, then each caregiver may use a different transcription service to transcribe visit notes. The format of the transcribed visit notes may vary between transcription services. It is unreasonable to require all transcription services to adopt a single format or to require a transcription service to use a special format for certain documents. Therefore, there is a need for an EMR system that accepts input document having a variety of formats.

Because many medical practices still rely upon paper records, it is difficult to identify patients that meet a certain set of criteria, such as the criteria for a clinical trial. Typically, a patient is a candidate for a clinical trial if the patient meets the age, gender and condition criteria for the clinical trial. If patient information is stored electronically, then the information needs to be searchable to identify patients that meet the criteria. Thus, there is a need for an EMR system that can easily identify patients that meet particular criteria.

To assist caregivers in treating patients, standard care guidelines have been promulgated. The care guidelines are updated as new information is discovered about medications and treatments. A caregiver may consult the care guidelines to confirm that a patient's treatment is consistent with the guidelines. If patient information is stored electronically, then the information needs to be automatically compared to the care guidelines to confirm that the patient's treatment is consistent with the guidelines. Thus, there is a need for an EMR system that integrates care guidelines.

### SUMMARY

The present invention meets the needs described above by providing a system and method for managing data and documents that accept input documents having a variety of formats so that caregivers are not required to modify their current mode of practice to use the system. The present invention also provides a method of extracting and storing data so that the data can be easily searched and retrieved.

In one aspect of the invention, the data management system receives input documents from a number of sources. The sources include transcription services and HL7 message sources. The format of the input documents is not constrained by the data management system, i.e. the system can accept input documents in any format. Therefore, a caregiver is not required to change or modify the caregiver's current mode of practice.

Once an input document is received by the data management system, a document reader parses the input document using a set of rules that are tailored to the source. Each source is associated with a document reader. Different document readers use different sets of rules. The rules define the data that is extracted from the document and describe how to locate the data in the document. Typically, demographic information and clinical information are extracted.

The data management system includes a number of databases and database brokers, including a Master Patient Index (“MPI”) Database and MPI Broker, a Document Database and Document Broker, an Audit Database and an Audit Broker, an Authorization Database and an Authorization Broker, and an Input Document Database and an Input Document Broker. The MPI Database stores demographic information extracted from the documents and uses the demographic information to index the documents stored in the Document Database. The Input Document Database stores copies of the input documents received from the various sources and the Document Database stores documents that include the data extracted from the input documents. The Audit Broker and the Audit Database maintain a record of all accesses and attempts to access the MPI Database and the Document Database. The Authorization Broker and the Authorization Database control access to the data management system by allowing only validated users access to the stored data.

By storing the input documents, the input document can be re-parsed if the rules are modified. The rules may be modified if additional or different information is desired. If the input documents are re-parsed, then the extracted data replaces that previously stored in the Document Database.

The data management system can be expanded by adding additional databases and database brokers. For example, a specialized database, such as a Care Guidelines Database, and an associated database broker can be added.

In another aspect of the invention, a transcription service creates an exemplary input document that includes demographic and clinical information. The document reader parses the input document using the appropriate rules to extract data. The rules use format and context to extract the data. If a specialized database, such as a Care Guidelines Database, is available, then the extracted data is analyzed to determine whether it is consistent with the information stored in the specialized database. For example, if the Care Guidelines Database includes treatment information for a heart attack, then the extracted data is analyzed to determine whether this condition is present. If so, then the prescribed treatment is compared to the recommended treatment in the Care Guidelines Database. If the prescribed treatment is consistent with the care guidelines, then a notice is included in the document that indicates the condition searched and the results of the comparison. However, if the prescribed treatment is not consistent with the care guidelines, then the notice indicates the condition searched and the missing treatment. The document created from the extracted data, including the results of the analysis, is stored in the Document Database. Alternatively, the notice can be sent via e-mail to the caregiver.

These and other aspects, features and advantages of the present invention may be more clearly understood and appreciated from a review of the following detailed description of the disclosed embodiments and by reference to the appended drawings and claims.

### BRIEF DESCRIPTION OF THE DRAWINGS

FIG. 1 is a block diagram of an exemplary data management system in accordance with an embodiment of the invention.

FIG. 2 is a block diagram of an exemplary broker in accordance with an embodiment of the invention.

FIG. 3 is a flow diagram of an exemplary method for storing data in accordance with an embodiment of the invention.

FIG. 4 is an example of an input document in accordance with an embodiment of the invention.

FIG. 5 is an example of the input document after the formatting has been removed in accordance with an embodiment of the invention.

FIG. 6 is an example of the rules used to extract data from the input document in accordance with an embodiment of the invention.

FIG. 7 is an example of the data extracted from the input document in accordance with an embodiment of the invention.

FIGS. 8 and 9 are examples of the document after performing care guidelines analysis in accordance with an embodiment of the invention.

FIGS. 10, 11, 12 and 13 are examples of data and document retrieval in accordance with an embodiment of the invention.

### DETAILED DESCRIPTION

The present invention is directed to a system and method for managing data and documents. Briefly described, a data management system receives input documents having a variety of formats from multiple sources. The input documents include transcribed dictation and HL7 messages. A document reader is associated with each source and with a set of rules. The rules are tailored to the formats used by the source. The rules use format and context to extract demographic and clinical data. The data extracted from the input document is stored in a document database and indexed. The extracted data is also compared to standard care guidelines to facilitate patient care.

Data Management System

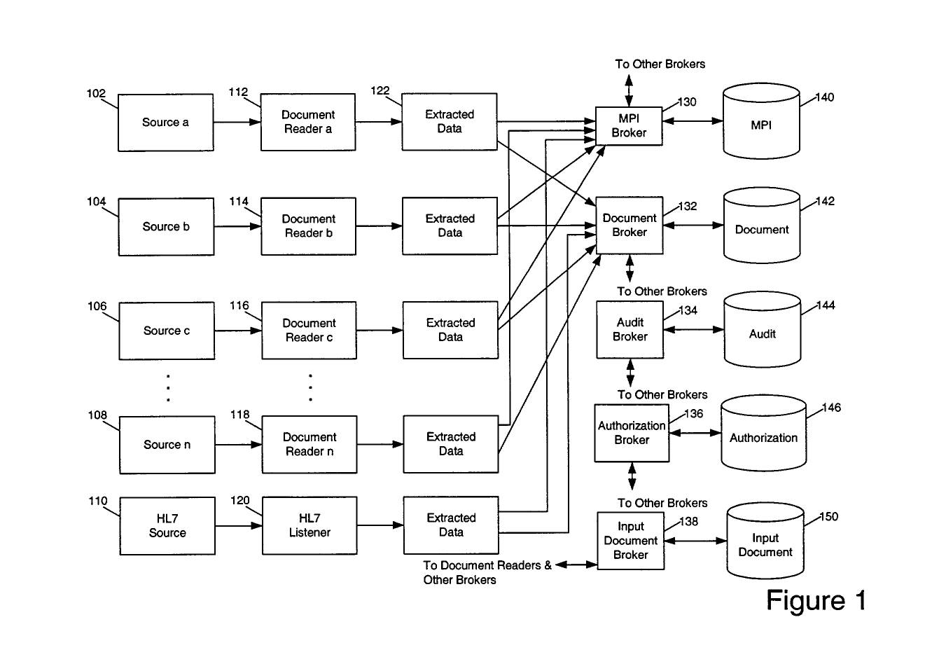

FIG. 1 illustrates the architecture for the data management system in one embodiment of the invention. The system receives input documents from a number of sources, including Source a 102, Source b 104, Source c 106, . . . Source n 108, and HL7 Source 110. In one embodiment the sources include transcription services. Typically, a physician or other caregiver dictates visit notes based on an examination of a patient. A transcription service transcribes the visit notes and creates an input document. The format of the input documents is not constrained by the data management system, i.e. the system can accept input documents in any format. Therefore, a caregiver is not required to change or modify the caregiver's current mode of practice. Similarly, the transcription service is not required to use a special format for documents for the data management system. The only requirement is that the input document includes sufficient information to identify the patient.

The data management system also accepts input from a source that provides HL7 messages 110. HL7 is a structured format that is commonly used for transmitting medical data. Other types of sources are also supported, including point-of-service workstations, other systems or databases, etc.

An input document is provided to the data management system by a source by sending the document via e-mail or direct file transfer, entering the information on a web page or in any other suitable manner. Once the input document is received by the data management system, the document is queued for processing. In one embodiment, all input documents from a particular source are placed in a single folder. A document reader is used to process the input document. Each source is associated with a document reader. For example, Document Reader a 112 is associated with Source a 102 and Document Reader b 114 is associated with Source b 104. A document reader parses an input document using a set of rules. Different document readers use different sets of rules. Although there may be some overlap in the rule sets, there is a set of rules associated with each source. For example, Document Reader a 112 and Document Reader b 114 each has a separate set of rules, even though some of the individual rules may be the same. In one embodiment, the association between the Document Reader/rule set and the source is based upon the location on the network of the folder containing the input document.

The rules define the data that is extracted from the document and describe how to locate the data in the document. In one embodiment, the rules use format and context to extract data. For example, the rules can define that a name is extracted from the document and describe that the name is located in a header after “Name:”. The rules can also use context to extract data. For example, the rules can extract various permutations of ten digit numeric strings to extract a telephone number. In addition, the rules can determine the sex of the patient based on the use of gender-specific pronouns or a gender-specific first name, even though the sex of the patient is not expressly stated in the input document.

In one embodiment, the extracted data includes demographic information and clinical information. The demographic information includes patient identification information, such as name, social security number, date of birth, medical record number and/or sex. The clinical information includes diagnosed conditions, medical test results, past medical procedures, symptoms, prescribed medications and dosages, and prescribed treatment.

The extracted data is validated and formatted. For example, if the extracted year data is “02” instead of 2002, then it is validated and formatted to 2002. In one embodiment, the extracted data 122 is internally represented as an XML document (after validation and formatting). However, other internal representations of the data are also possible. The Document Readers communicate with the Master Patient Index (“MPI”) Broker 130 and the Document Broker 132 to store and index the extracted data.

If the source is an HL7 Source, then an HL7 Listener 120 is used rather than a document reader. The HL7 Listener parses an HL7 input message using a set of rules. Like the rules associated with a document reader, the rules associated with an HL7 listener define the data that is to be extracted from the input HL7 message. Different HL7 listeners use different sets of rules. The HL7 Listener 120 communicates with the MPI Broker 130 and the Document Broker 132 to store and index the data extracted from the HL7 message. Although FIG. 1 illustrates that the data extracted from the HL7 message is stored in the Document Database, the data may be stored in an HL7 Database (not shown).

The MPI Broker 130 controls access to the MPI Database 140 which stores demographic information extracted from the input documents. In one embodiment, the MPI Database stores patient information and the documents containing the extracted information are indexed based on patient information. Prior to storing a document in the Document Database, the MPI broker determines whether a record exists in the MPI database for the patient associated with the document. If a record exists, then the document is indexed using the existing patient information. If a record does not exist, then the MPI broker creates a record in the MPI database for the patient. The Document Broker 132 controls access to the Document Database 142 which stores the extracted data, as well as the location of a copy of the input document. In one embodiment, the extracted data is stored in a format that facilitates display via an Internet browser.

The data management system also includes an Audit Broker 134 and an Audit Database 144. The Audit Broker controls access to the Audit Database. The Audit Broker and the Audit Database create and store audit log information to maintain a record of all accesses and attempts to access the MPI Database and the Document Database.

The Authorization Broker 136 controls access to the Authorization Database 146. The Authorization Broker and the Authorization Database control access to the data management system by allowing only validated users to access the stored data. User Names and passwords are created and maintained by the Authorization Broker and the Authorization Database.

The data management system illustrated by FIG. 1 can be expanded to include other elements. In particular, the system can be expanded by adding other process management tools, such as a scheduler, and other databases. Additional brokers and databases can be added in a modular fashion. The additional brokers communicate with the other brokers and possibly with the document readers.

If an additional element is added, then the MPI Database stores patient information for the additional element. For example, if a scheduler is added, then the scheduler can use the patient data stored in the MPI Database. Similarly, the Audit Broker and the Audit Database can be used to create an audit log for the additional element and the Authorization Broker and the Authorization Database can be used to control access to the additional element. Thus, the MPI Broker and MPI Database, the Audit Broker and the Audit Database, and the Authorization Broker and the Authorization Database accommodate future enhancements to the system by supporting additional elements that are plugged in to the architecture illustrated by FIG. 1.

In one embodiment, a Care Guidelines Broker and a Care Guidelines Database are included (not shown). The Care Guidelines Database includes suggested treatments for certain conditions. Typically, the suggestions are based on national standards or guidelines. In one embodiment, the Care Guidelines Database associates a condition or a range of values with a treatment. For example, the Care Guidelines Database may suggest treating a patient who has had a heart attack with ace inhibitors and lipid lowering medications or flag a cholesterol value that exceeds a recommended value. The Care Guidelines components are used to analyze a document and to provide prompts or notifications if the treatment described in the document is inconsistent with the guidelines. In one embodiment the document can be compared to the guidelines as the Document Reader and the Document Broker process the document. In another embodiment, a software agent can periodically scan either the input documents or the documents to extract condition and/or treatment information and compare the extracted information to the care guidelines. Typically, if the information has been extracted, then the documents in the Document Database are scanned. However, if the information has not been extracted, then the input documents are scanned.

In another embodiment, a Custom Broker and a Custom Database are included (not shown). The Custom Database includes information specific to a particular application. For example, the Custom Database may include practice-specific guidelines. Again, the Custom Broker communicates with the Document Broker to analyze the document and to determine whether the practice-specific guidelines have been followed. If both a Care Guidelines Database and a Custom Database are included, then the guidelines are applied in a hierarchal manner, typically by applying the national guidelines associated with the Care Guidelines Database before the practice-specific guidelines associated with the Custom Database. Both the Care Guidelines Database and the Custom Database can be updated from an external source whenever new information is available.

The documents stored in the Document Database can be queried and retrieved. Typically, a query specifies demographic or patient information. For example, a query can request a list of all documents associated with a particular name. In one embodiment, a query can be entered via a web page.

Although the foregoing discussion describes that the documents are indexed using demographic information, such as patient information, additional or alternative indexing is also possible. For example, the documents could be indexed based upon a prescribed medication or diagnosed condition. If so, then a query can specify a medication or a condition to request a list of all documents that include the medication or the condition. To index the documents according to another characteristic of the extracted data, an additional broker and a database are needed. If an additional broker is used, then the document readers communicate with both the MPI Broker and the additional broker so that the documents are indexed according to both demographic information and the other type of information. As an alternative to adding an additional broker and database, ad-hoc indexing may be used.

Indexing the documents according to medication facilitates identifying patients that are taking a specific medication. As new information about the medication becomes available, patients taking the medication can be readily identified so that their treatment can be reviewed in light of the new information. Similarly, indexing the documents according to condition facilitates identifying patients having a specific condition. As new information about the condition becomes available, patients with the condition can be readily identified so that their treatment can be reviewed in light of the new information. In addition, patients with the condition can be identified as potential candidates for a clinical trial directed to the condition.

The data management system also stores a copy of the input document in the Input Document Database 150 which allows the stored input document to be re-parsed if the rules are modified. In one embodiment, the input documents are stored in a file system indexed by a unique document identifier. If the input documents are re-parsed, then the extracted data replaces that previously stored in the Document Database 142. For example, if the original rules did not extract information for a particular over-the-counter medication, but it is later determined that use of the medication is helpful in evaluating the patient's condition, then the rules can be modified to extract information on the medication. Typically, the rules associated with each Document Reader are modified and all the input documents are re-parsed using the modified rules to obtain the information.

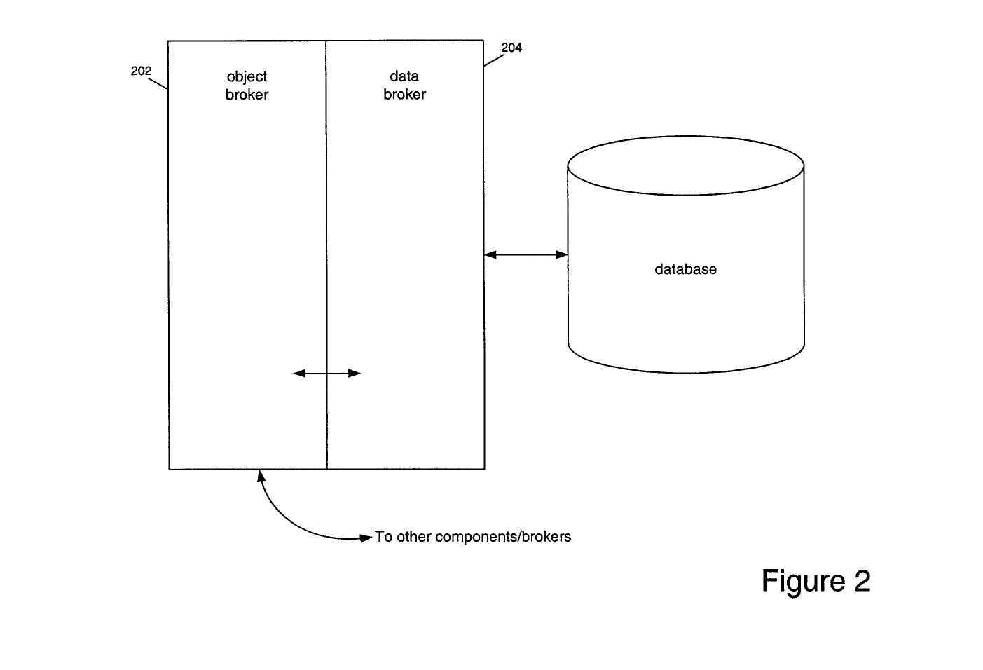

FIG. 2 provides additional details for the database brokers discussed in connection with FIG. 1. As shown in FIG. 2, a broker includes an object broker 202 and a data broker 204. The object broker and the data broker communicate with each other. In addition, the object broker implements business rules and communicates with the other components in the system, including other brokers. For example, the object broker of the MPI Broker communicates with the object broker of the Audit Broker to create an audit log whenever data is stored or retrieved from the Document Database. Similarly, the object broker of the MPI Broker communicates with the object broker of the Authorization Broker to validate a user whenever a user attempts to access data from the Document Database. The data broker manages data storage and retrieval from the associated database.

Extracting and Storing Data

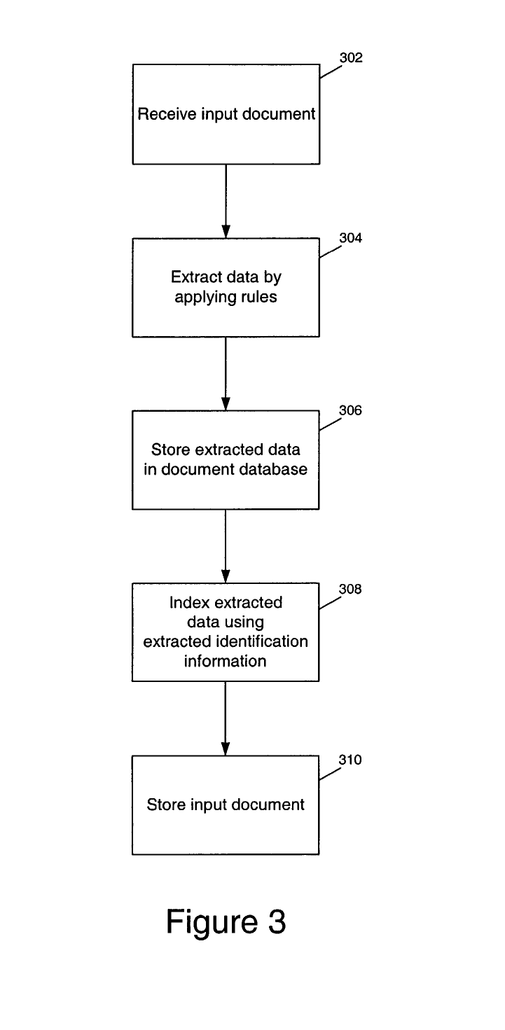

FIG. 3 is a flow diagram illustrating an exemplary method for extracting and storing data. In step 302 an input document is received from a source. Once the document is received, a set of rules that correspond to the source is used to parse the document to extract data in step 304. As discussed above in connection with FIG. 1, different rule sets are associated with different sources, so that the system can process input documents from a variety of sources having a variety of different formats. In step 306, the extracted data is stored in the Document Database. In addition, the extracted data is indexed in step 308. The data is indexed using identification information extracted from the input document. In one embodiment, the identification information is demographic information, such as patient name, social security number, date of birth, medical records number etc. The original input document is stored in the Input Document Database in step 310. Although steps 306, 308 and 310 are shown as occurring in sequence, those skilled in the art will appreciate that the steps can occur in a different order or in parallel.

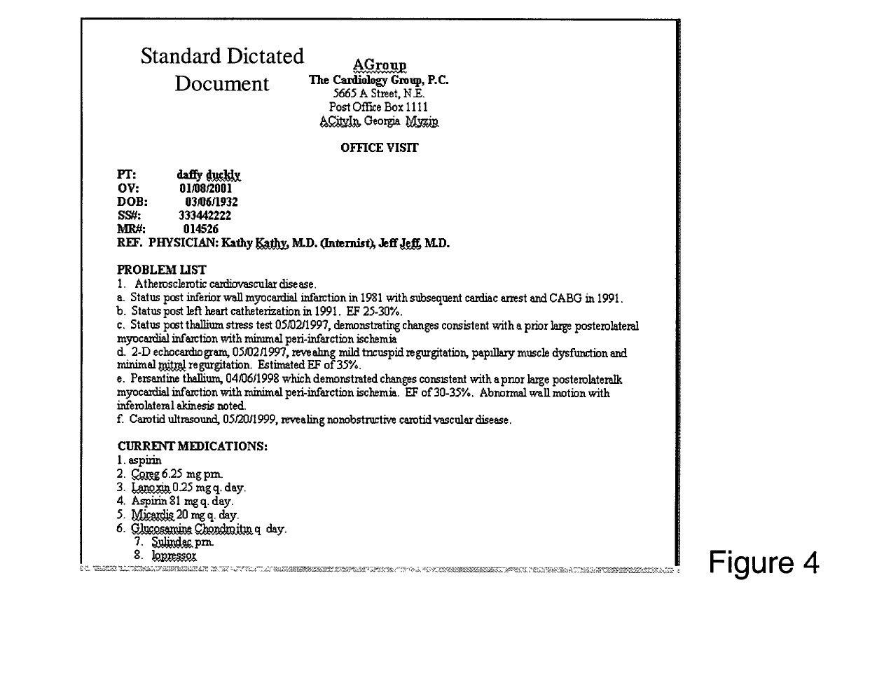

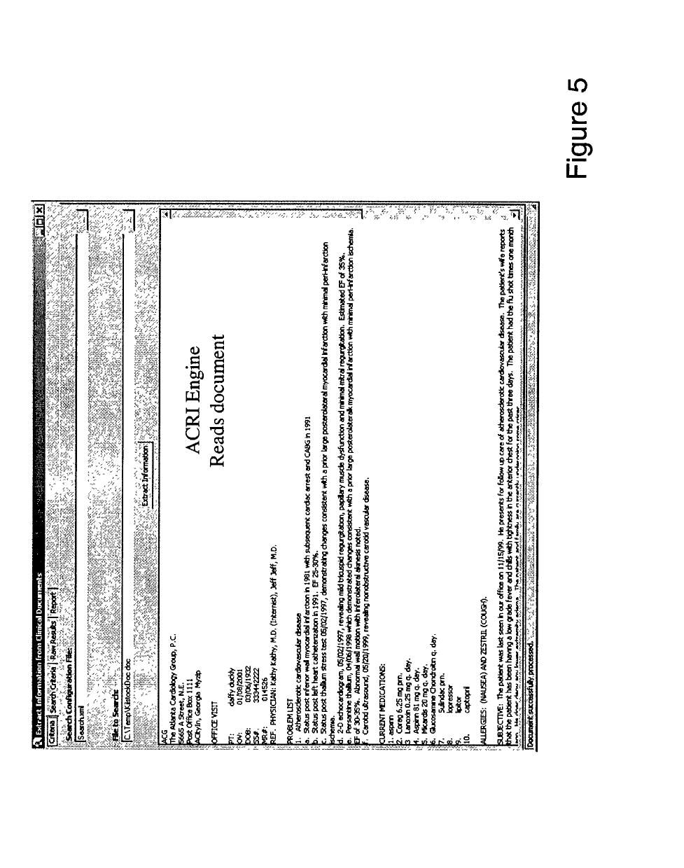

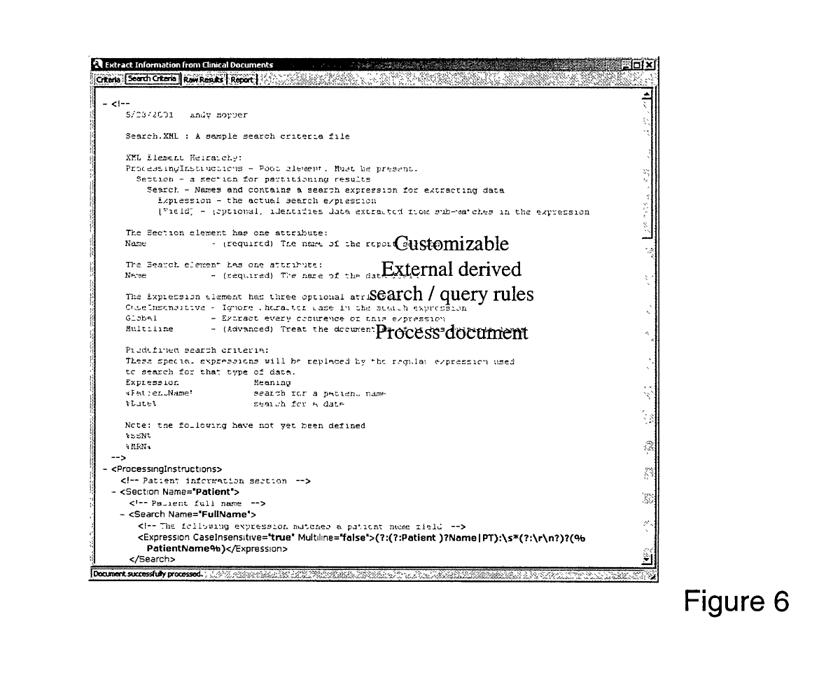

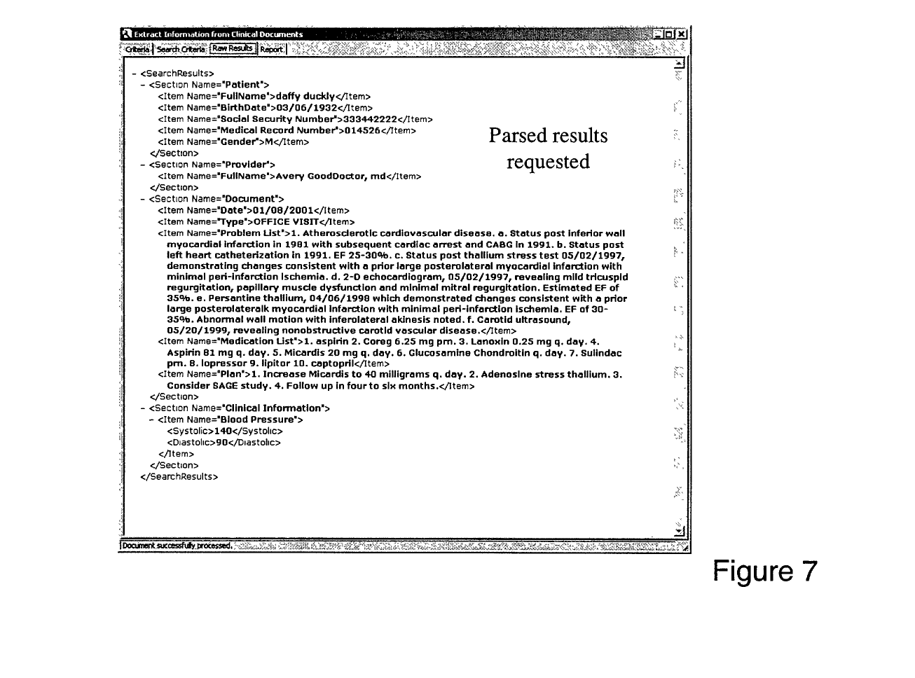

FIGS. 4-9 further illustrate the process of extracting and storing data in one embodiment of the invention. FIG. 4 illustrates an exemplary input document created by a transcription service. The input document includes patient information, provider information, a list of problems experienced by the patient, a list of current medications, a list of known allergies, subjective observations, etc. In one embodiment, the document reader starts processing the input document by removing the formatting. FIG. 5 illustrates the document of FIG. 4 with the formatting removed. FIG. 6 illustrates the rule set for the source that provided the document of FIG. 4. In particular, FIG. 6 illustrates the rules used to extract a patient name from the input document. In one embodiment, each rule set includes a library of regular expressions that define how information is delimited. A PERL language regular expression parser is used along with the rule set to extract the data. FIG. 7 illustrates an internal representation of the extracted data. In the embodiment illustrated by FIG. 7, the internal representation is an XML Document.

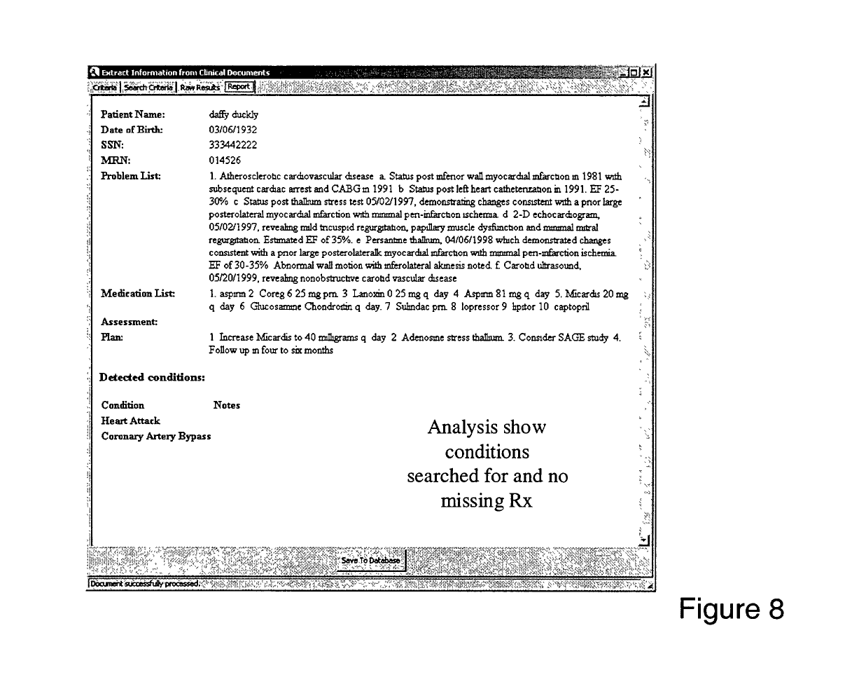

If a Care Guidelines Database is included, then once the data is extracted, the data is analyzed to determine whether it is consistent with national care guidelines. FIG. 8 illustrates the document of FIG. 7 after it has been analyzed. The results of the analysis are summarized under the section entitled “Detected Conditions”. In the example of FIG. 8, the analysis searched for two conditions, heart attack and coronary artery bypass, which are listed under the “Condition” heading. The extracted data is consistent with the care guidelines so no additional information is provided under the “Notes” heading.

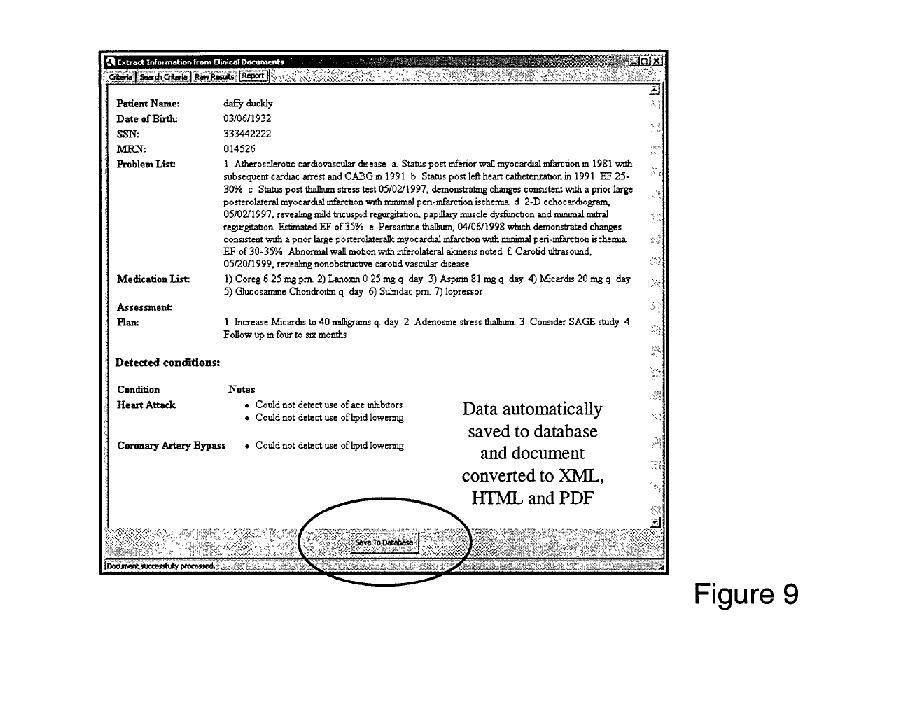

Alternatively, if the analysis finds that the extracted data is inconsistent with the care guidelines, then additional information is provided under the “Notes” heading as illustrated by FIG. 9. The analysis searched for the same two conditions, heart attack and coronary artery bypass. However, in this example the extracted data is not consistent with the care guidelines because the extracted data does not indicate the use of ace inhibitors or lipid lowering medications. Therefore, the absence of these medications is noted under the “Notes” heading.

The document of FIG. 8 or 9 can be saved in the Document Database, so that the analysis information is available when the document is retrieved. Alternatively, or in addition to saving the information, a notification can be generated whenever an inconsistency is detected in the extracted data and the guidelines. In one embodiment, the notification is an electronic mail message sent to the caregiver.

Retrieving Data

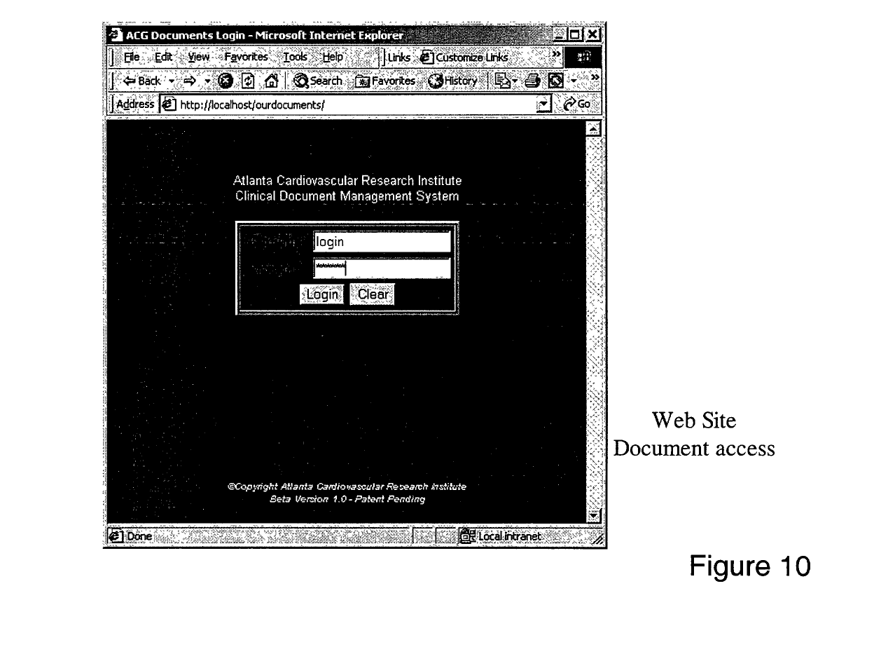

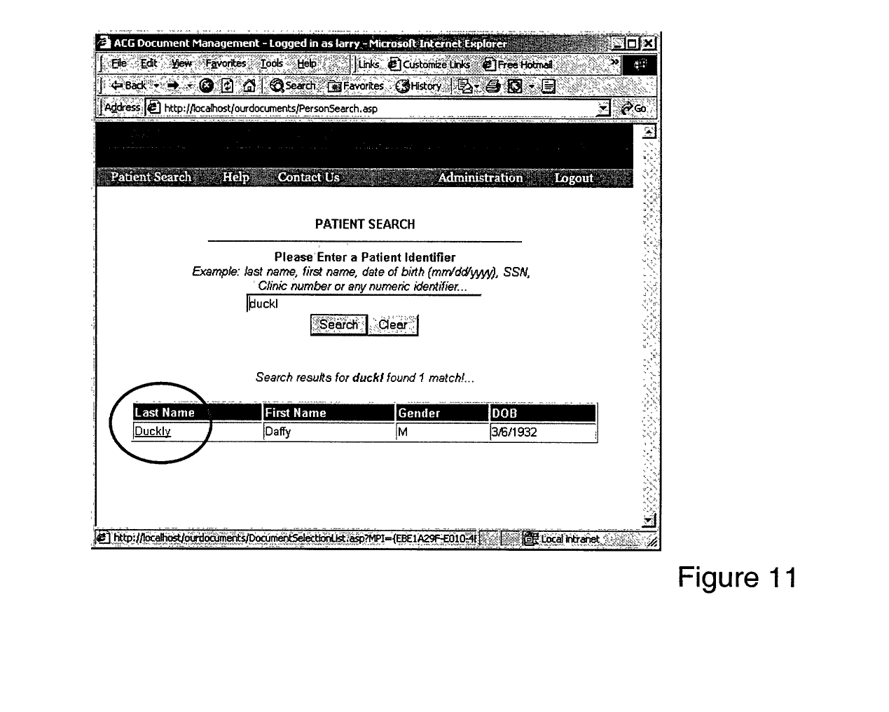

FIGS. 10-13 illustrate the process of retrieving data and documents. In one embodiment of the invention, the data is accessed via a web page so that a variety of front end systems can be used to access the data. FIG. 10 illustrates an exemplary web page that requests a username and password. Once the username and password are entered, the Authorization Database validates the username and password. If the username and password are valid, then the user is prompted to enter a patient identifier, such as last name, first name, date of birth, social security number, etc. FIG. 11 illustrates that the user enters a portion of a patient name, “duck1”, and that the system searches the MPI database and locates one patient with the name of “Duckly”.

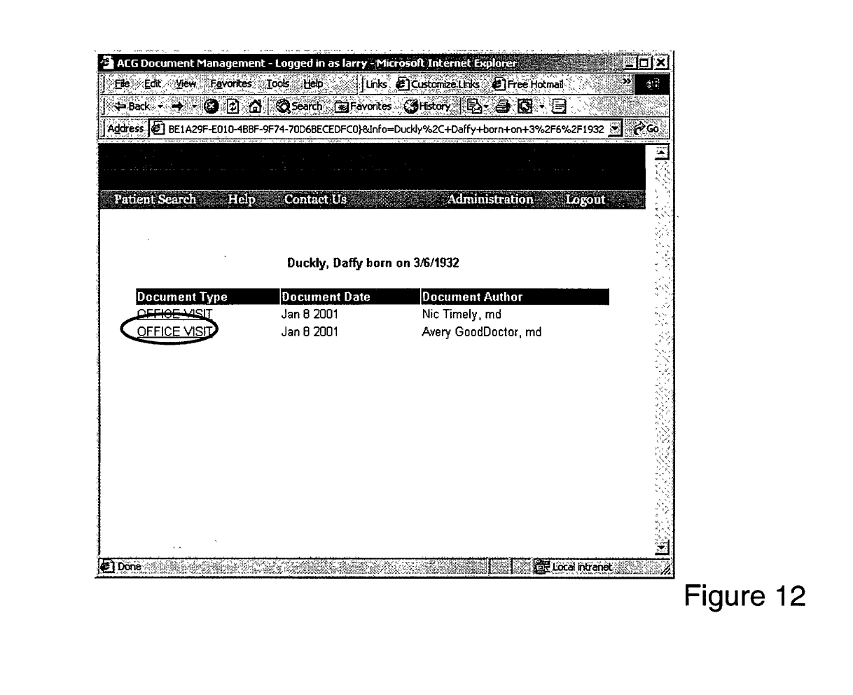

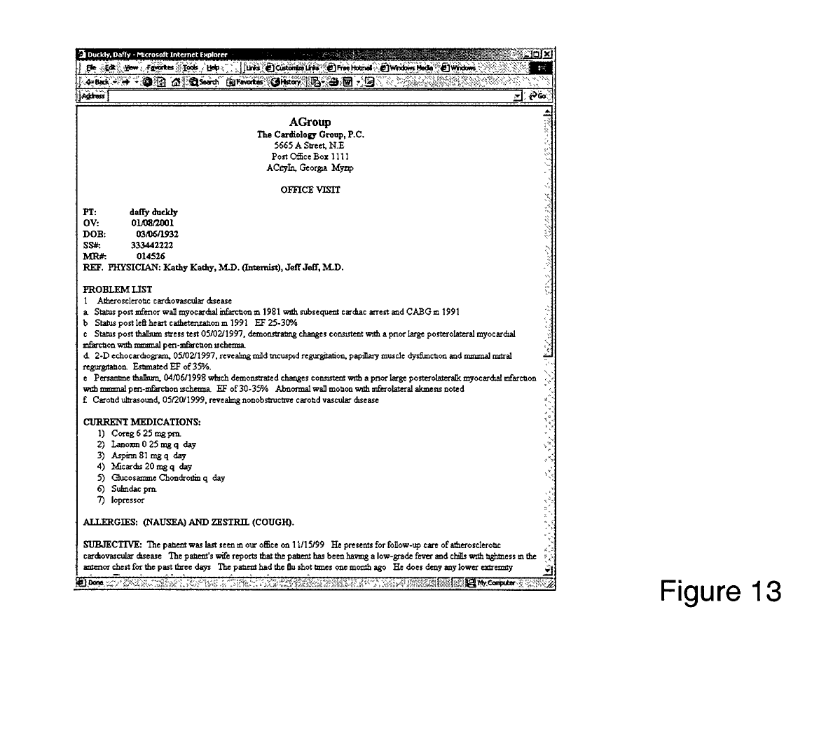

If the user selects patient Duckly, then a list of the documents associated with the patient are displayed as shown in FIG. 12. FIG. 12 illustrates that two office visit document are located for the patient. If the user selects one of the documents, then the document is displayed to the user as shown in FIG. 13.

The data management system can be used to identify patients for clinical trials. Typically, a patient is a candidate for a clinical trial if the patient meets certain criteria, such as age, sex and diagnosed condition. In one embodiment, a search can be performed to locate patients within an age range by entering a range of birth dates. Once the patients within the age range are located, the patient information is reviewed to locate patients of the desired sex. The documents for those patients can be reviewed to identify the patients that have been diagnosed with the condition that is the subject of the clinical trial. Alternatively, if the patient records are indexed based on condition, as well as patient information, the search criteria can include condition information.

Additional alternative embodiments will be apparent to those skilled in the art to which the present invention pertains without departing from its spirit and scope. In particular, the present invention can be used with all types of documents and is not limited to medical records. Accordingly, the scope of the present invention is described by the appended claims and is supported by the foregoing description.

What is claimed is:

1. A method for storing data from a plurality of sources, comprising:
receiving a plurality of input documents, each input document including demographic information;
parsing each input document by applying a set of rules corresponding to the source associated with the input document to extract demographic data and clinical data;
storing the extracted data in a document database;
determining whether the demographic data corresponds to an existing index record; and
if the demographic data corresponds to an existing index record, then indexing the extracted data based on the demographic data.

2. The method of claim 1, further comprising:
storing the input document;
updating the set of rules corresponding to the source;
re-parsing the input document by applying the updated set of rules to extract updated demographic data and updated clinical data; and
storing the updated extracted data in the document database.

3. The method of claim 1, further comprising:
if the individual information does not correspond to an existing index record, then creating an index record using the demographic information.

4. The method of claim 1, further comprising:
comparing a value extracted from the input document to a predetermined value;
based on the comparison, identifying a treatment guideline; and
comparing the treatment guideline with a treatment extracted from the input document.

5. The method of claim 4, further comprising:
based on the treatment comparison, providing a notice of the comparison.

6. The method of claim 1, further comprising:
comparing a condition extracted from the input document to a predetermined condition;
based on the comparison, identifying a treatment guideline; and
comparing the treatment guideline with a treatment extracted from the input document.

7. The method of claim 6, further comprising:
based on the treatment comparison, providing a notice of the comparison.

8. The method of claim 1, wherein one of the documents is a transcribed document.

9. The method of claim 1, wherein one of the documents is an HL7 message.

10. The method of claim 1, wherein the set of rules includes a rule based on a location in the input document.

11. The method of claim 1, wherein the set of rules includes a rule based on a field in the input document.

12. The method of claim 1, wherein the set of rules includes a rule based on context of the input document.

13. A system for storing data received from multiple sources, comprising:
a plurality of document readers, wherein each document reader is associated with a different source and each document reader is associated with a set of rules, is operative to extract data from an input document received from its associated source using the set of rules and is operative to communicate with an index broker and a document broker;
an index database for storing demographic data extracted from the documents and indexing the extracted data;
the index broker operative to receive data from the document readers, to store and retrieve data from the index database and to communicate with the document broker;
a document database for storing the extracted data from the input documents; and
the document broker operative to receive the extracted data from the document readers, to store and retrieve data from the document database and to communicate with the index broker.

14. The system of claim 13, further comprising:
an audit database for storing audit information; and
an audit broker operative to store and retrieve audit information from the audit database and to communicate with the index broker.

15. The system of claim 13, further comprising:
an authorization database for storing authorization information; and
an authorization broker operative to store and retrieve authorization information from the authorization database and to communicate with the index broker.

16. The system of claim 13, further comprising:
a care guidelines database for storing care guidelines information; and
a care guidelines broker operative to store and retrieve care guidelines information from the care guidelines database and to communicate with the document broker.

17. The system of claim 13, further comprising:
a practice-specific database for storing practice specific information; and
a practice-specific broker operative to store and retrieve practice specific information from the practice specific database and to communicate with the document broker.

18. A method for storing data, comprising:
receiving an input document from a source;
identifying a set of rules associated with the source that use format and context to extract data;
applying the set of rules to the input document to extract demographic data and clinical data;
comparing the clinical data to care guideline information;
reporting results of the comparison;
storing the demographic data and the clinical data; and
indexing the extracted data using the demographic data.

19. The method of claim 17, wherein the source is a transcription service and the input document is a transcribed document.

20. The method of claim 17, wherein reporting results of the comparison comprises providing an electronic mail notification.

21. The method of claim 17, wherein reporting results of the comparison comprises storing the results with the extracted data.

22. The method of claim 17, wherein the extracted data is stored in a document database and the demographic data is used to index the extracted data in an index database.

23. A method for storing and retrieving medical documents, comprising:
receiving an input medical document from a source;
identifying a set of rules based on the source;
applying the set of rules to the input medical document to extract demographic data and clinical data;
storing the demographic data and clinical data as a document;
indexing the document using the demographic data; and
retrieving the document.

24. The method of claim 23, wherein retrieving the document comprises:
receiving a search request that includes identification information for a patient;
based on the identification information, identifying demographic data that corresponds to the patient;
using the demographic data to identify the document;
receiving a document selection for the document; and
providing the document in response to the document selection.

25. The method of claim 24, wherein identifying the document comprises:
displaying a document identifier that corresponds to the document on a display device.

26. The method of claim 24, wherein providing the document comprises:
displaying the document on a display device.

27. The method of claim 24, wherein the identification information comprises a portion of a name.

28. The method of claim 24, wherein the identification information comprises a date of birth.

29. The method of claim 24, wherein the identification information comprises a medical record number.
